(19) United States
(12) Patent Application Publication
(10) Pub. No.: US 2024/0320617 A1
(43) Pub. Date: Sep. 26, 2024

(54) STORE MANAGEMENT SYSTEM, METHOD PERFORMED THEREBY, AND STORE SERVER

(71) Applicant: Toshiba Tec Kabushiki Kaisha, Tokyo (JP)

(72) Inventor: Syuji YABU, Mishima Shizuoka (JP)

(21) Appl. No.: 18/528,695

(22) Filed: Dec. 4, 2023

(30) Foreign Application Priority Data
Mar. 24, 2023 (JP) 2023-048724

(51) Int. Cl. G06Q 10/087; G09F 3/20

(52) U.S. Cl. CPC G06Q 10/087; G09F 3/208

(57) ABSTRACT

A store management system includes electronic shelf labels each displaying item information indicating one of items sold in a store, a shelf label server communicating with the labels and store the item information displayed by each label in association with a corresponding shelf label location information indicating a location of said each label in the store, and a store server storing, in a memory, item location information for each item that indicates a location of said item in the store in association with an item code, retrieve, from a database, item information for each item using the code, and for each item, transmit the item information along with the item location information thereof to the label server. The label server transmits each item information to a selected label for display thereby. The selected label is located at or nearest to the location indicated by the item location information.

### CROSS-REFERENCE TO RELATED APPLICATION(S)

This application is based upon and claims the benefit of priority from Japanese Patent Application No. 2023-048724, filed Mar. 24, 2023, the entire contents of which are incorporated herein by reference.

### FIELD

Embodiments described herein relate generally to a store management system, a method performed thereby, and a store server.

### BACKGROUND

Some retail stores such as grocery stores and convenience stores use an electronic shelf label system in addition to a POS (Point of Sale) system. By using the electronic shelf label system in combination with the POS system, the electronic shelf label system can obtain item information such as item names, prices, and the like managed by the POS system. By sharing the item information, for example, a price displayed on an electronic shelf label is immediately changed in accordance with the change of the selling price of the corresponding item.

This type of retailer regularly inspects the item shelves. In this operation, an employee goes around a sales floor to check each item shelf, and inputs information indicating which item is placed in which place to an information terminal. The information input to the information terminal is transmitted to the upper level system through the POS system. The upper level system generates and outputs, based on the information input to the information terminal, marketing data used for considering, for example, a layout change of an item shelf or a change in the arrangement location of an item.

### SUMMARY OF THE INVENTION

Incidentally, information input to an information terminal at the time of an inspection operation of an item shelf includes the location information of an item. The location information indicates the sales floor, the item shelf, and the tier and section of the shelf on which the item is located, and corresponds to the position information of the electronic shelf label attached to the section. Therefore, when an investigating employee finds an electronic shelf label of an item at a location that is indicated on the information terminal, it can be said that the display of the electronic shelf label is correct. Therefore, it is very efficient if the display of the electronic shelf label can be checked in accordance with the inspection operation of the item shelf. For this purpose, a mechanism is needed for sharing information input to the information terminal by the electronic shelf label system.

Embodiments of the present invention provide a mechanism for automatically sharing information that is input to a POS system in an inspection operation of an item shelf with an electronic shelf label system.

In one embodiment, a store management system, comprises a plurality of electronic shelf labels each configured to display item information indicating one of a plurality of items sold in a store; a shelf label server configured to communicate with the electronic shelf labels and store the item information displayed by each of the electronic shelf labels in association with a corresponding shelf label location information indicating a location of said each of the electronic shelf labels in the store; and a store server. The store server is configured to: store, in a memory, item location information for each of the items that indicates a location of said each of the items in the store in association with an item code of said each of the items, retrieve, from a database, item information for each of the items using the item code of said each of the items, and for each of the items, transmit the item information retrieved from the database using the item code thereof along with the item location information thereof to the shelf label server. The shelf label server is configured to transmit each item information received from the store server to a selected electronic shelf label for display by the selected electronic shelf label. The selected electronic shelf label is one of the electronic shelf labels that is located at or nearest to the location indicated by the item location information received with the item information.

### BRIEF DESCRIPTION OF THE DRAWINGS

FIG. 1 is a diagram illustrating a POS system and an electronic shelf label system used in a store.

FIG. 2 is a schematic diagram of a main data structure of an item record stored in an item master of the POS system.

FIG. 3 is a schematic diagram of a main data structure of a shelf label record stored in a shelf label master of the electronic shelf label system.

FIG. 4 is a hardware block diagram of a store server in the POS system.

FIG. 5 is a schematic diagram of a data structure of a shelf information area stored in the store server.

FIG. 6 is a flowchart of first information processing executed by the store server.

FIG. 7 is a flowchart of second information processing executed by the store server.

### DETAILED DESCRIPTION

Hereinafter, embodiments of an information processing apparatus capable of sharing information input to an information terminal in an inspection operation of an item shelf by an electronic shelf label system will be described with reference to the drawings.

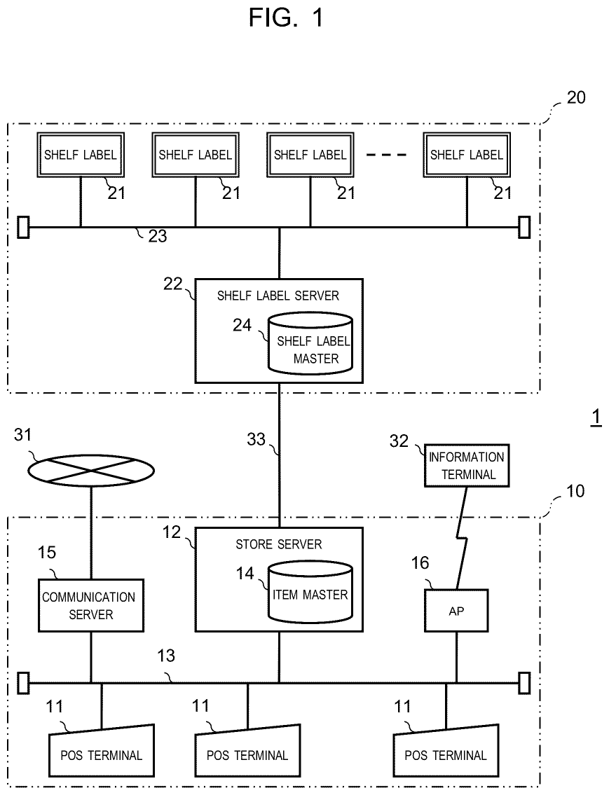

The information processing apparatus in an embodiment is used in a store management system 1 including a POS system 10 and an electronic shelf label system 20. First, a configuration of such a system used in a store will be described with reference to FIGS. 1 to 3.

FIG. 1 is a block diagram of a main system configuration of the store management system 1. The store management system 1 includes the POS system 10 and the electronic shelf label system 20 connected to each other via a network.

The POS system 10 includes a plurality of POS terminals 11 and a store server 12 that manages the POS terminals 11. The POS system 10 connects the POS terminals 11 and the store servers 12 via a communication network 13. In the POS system 10, the store server 12 collects sales data of items registered for sales from the POS terminals 11 via the communication network 13 for sales management.

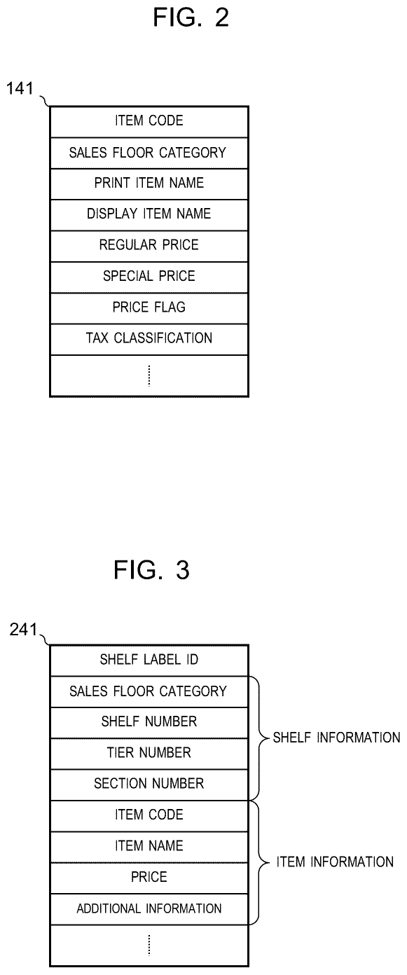

The store server 12 includes an item master database 14 (hereinafter simply referred to as “item master”). The item master 14 is an aggregate of item records 141 (see FIG. 2) each corresponding to an item sold at a store.

FIG. 2 is a schematic diagram of a main data structure of an item record 141. The item record 141 includes fields such as an item code, a sales floor category, a print item name, a display item name, a regular price, a special price, a price flag, and a tax classification.

The item code is a unique code set for each item in order to identify the item. The item code is, for example, a JAN (Japanese Article Number) code. The item code may be an in-store marking code. A bar code indicating an item code is attached to each item.

The sales floor category is identification information of a sales floor in which the corresponding item is sold. Sales floors are classified by item categories. In the item shelves on a sales floor, items belonging to an item category are displayed and sold. Each of the sales floors is assigned a unique sales category.

The print item name is an item name printed on a receipt paper by a receipt printer of the POS terminal 11. The displayed item name is the item name displayed on the display device of the POS terminal 11. The regular price is a sales price per item at normal times. The special price is a sales price per item at the time of bargain sale. The price flag is 1-bit data for identifying whether the regular price is valid or the special price is valid. In an embodiment, the price flag is set to “0” when the regular price is valid, and the price flag is set to “1” when the special price is valid. The tax classification is information for identifying whether the tax is included, excluded, or an exemption.

Returning to the description of FIG. 1, the POS system 10 includes a communication server 15. The communication server 15 is a computer that provides a data communication service with an upper level server connected via a wide area communication network 31 such as the Internet or an intranet. The upper level server is, for example, a server of a headquarters system that manages the entire operation of a store.

An access point (AP) 16 is connected to the communication network 13 of the POS system 10. The access point 16 is a device for performing wireless communication with a portable or mobile information terminal 32 such as a tablet terminal or a smartphone. Any number of access points 16 can be used in the store system. In consideration of the size of the store and the layout of the sales floor, two or more access points 16 may be installed in the store and connected to the communication network 13.

The electronic shelf label system 20 includes a plurality of electronic shelf labels 21 and a shelf label server 22 that collectively controls the electronic shelf labels 21. The electronic shelf label system 20 is formed by connecting each electronic shelf label 21 and the shelf label server 22 via a communication network 23. Each electronic shelf label 21 is attached to an item shelf in association with an item placed on the item shelf. The electronic shelf label system 20 distributes display data from the shelf label server 22 to each electronic shelf label 21 via the communication network 23, and causes each electronic shelf label 21 to display the item name, price, and the like of an item.

The shelf label server 22 stores a shelf label master database 24 (hereinafter simply referred to as “shelf label master”). The shelf label master 24 is an aggregate of shelf label records 241 (see FIG. 3) each corresponding to an electronic shelf label 21.

FIG. 3 is a schematic diagram of a main data structure of each shelf label record 241. The shelf label record 241 includes a shelf label ID, shelf information, and item information. The shelf label ID is unique identification information assigned to each electronic shelf label 21 in order to individually identify the electronic shelf label 21. The electronic shelf label 21 stores the shelf label ID assigned to the electronic shelf label in a built-in memory.

The shelf information includes a sales floor category, a shelf number, a shelf number, and a section number. The sales floor category, the shelf number, the shelf number, and the section number are pieces of information regarding the location of the item shelf to which the electronic shelf label 21 identified by the shelf label ID of the same record is attached. In other words, the shelf information included in the shelf label record 241 is location information indicating the sales floor, the item shelf, and the tier and section of the shelf of the electronic shelf label 21.

The sales floor is identified by a sales floor category. The sales floor category is identification information of a sales floor in which an item shelf is installed. Each of the sales floors has a unique sales floor category. The item shelf is identified by a shelf number. The shelf number is a series of numbers allocated for each of the item shelves installed on the sales floor identified by the sales floor category. For example, in a case where three item shelves are installed on one sales floor, shelf numbers of “1”, “2”, and “3” are allocated to each item shelf.

Tiers or stages of a shelf are specified by tier numbers. The tier number is a value in which, for example, the lowermost tier of an item shelf is set as the first tier, and the tier number is increased by “1” for upper tiers, e.g., the second and third tiers. Sections of each tier are specified by section numbers. In each item shelf, a tier is partitioned into two or more sections. The section number is a value that increases by “1” so that, for example, the leftmost section of the tier is set as the first section and assigned “1”, and the adjacent sections on the right are set as the second and third sections and assigned “2” and “3”.

Therefore, for example, when the sales floor category is “A”, the shelf number is “1”, the tier number is “2”, and the section number is “3”, the electronic shelf label 21 identified by the shelf label ID is attached to the second tier from the bottom and the third section from the left of the first item shelf on the sales floor A.

The item information includes an item code, an item name, a price, additional information, and the like. The item code, the item name, the price, the additional information, and the like are displayed on the electronic shelf label 21 identified by the shelf label ID of the same record. Normally, each electronic shelf label 21 displays information on an item placed in a section to which the electronic shelf label 21 is attached. As an example, the item code, the item name, the price, and the additional information of the placed item are displayed on the electronic shelf label 21. The item code may be displayed in the form of a bar code or a two-dimensional code. The additional information is promotional information indicating, for example, a “bargain sale item”, a “recommended item”, an “advertisement item”, a “number of points to be awarded”, and the like.

Returning to the description of FIG. 1, the store server 12 and the shelf label server 22 are connected by an inter-server network 33. This connection enables bidirectional data communication between the store server 12 and the shelf label server 22.

The information terminal 32 is carried by an employee who performs an inspection operation of an item shelf. The employee periodically goes around the sales floor to check an item shelf, and inputs information indicating which item is placed in which place to the information terminal 32. Specifically, the employee inputs, to the information terminal 32, the item code, the sales floor category, the shelf number, the tier number, and the section number for each item placed on the checked item shelf. The sales floor category is a sales floor category of the sales floor where the item is placed. The shelf number is a shelf number of the item shelf on which the item is placed. The tier number is a tier number on which the item is placed. The section number is a section number in which the item is placed. That is, the shelf information input to the information terminal 32 is location information indicating a place where the item is placed. In the following description, paired data of an item code and shelf information input to the information terminal 32 is referred to as shelf inspection data.

The shelf inspection data input to the information terminal 32 is wirelessly transmitted to the store server 12 via the access point 16. The store server 12 transmits the shelf inspection data to the upper level server via the communication server 15. The shelf inspection data transmitted to the upper level server is important data when the store operator considers, for example, a layout change of an item shelf or a location change of an item.

In an embodiment, the store server 12 has an assist function for sharing shelf inspection data with the electronic shelf label system 20, a so-called sharing assist function. Next, the store server 12 having the sharing assist function will be described in detail.

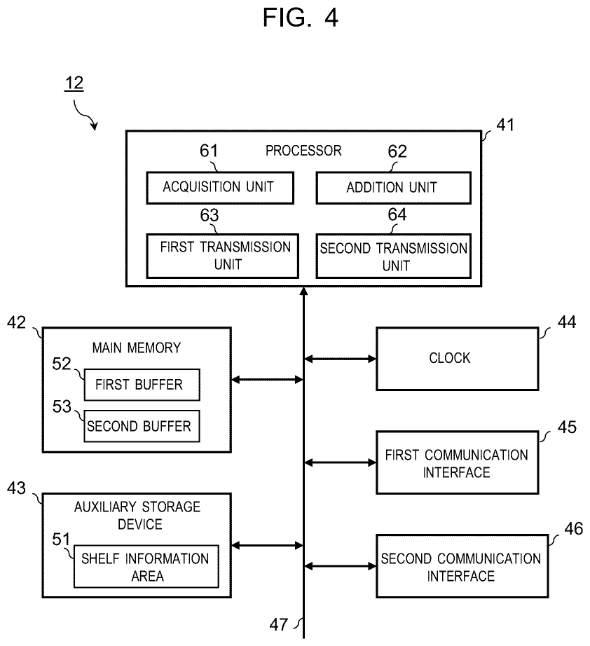

FIG. 4 is a hardware block diagram of the store server 12. The store server 12 includes a processor 41, a main memory 42, an auxiliary storage device 43, a clock 44, a first communication interface 45, a second communication interface 46, a system transmission path 47, and the like. The system transmission path 47 includes an address bus, a data bus, a control signal line, and the like. The system transmission path 47 connects the processor 41 and the other components, and conveys data signals exchanged between them.

The processor 41, the main memory 42, and the auxiliary storage device 43 may form a controller connected to the clock 44, the first communication interface 45, and the second communication interface 46 via the system transmission path 47.

The processor 41 corresponds to a central component of the controller. The processor 41 controls each component of the store server 12 to perform various functions in accordance with an operating system and one or more application programs. The processor 41 is, for example, a CPU (Central Processing Unit). The processor 41 may be a multi-core processor including a plurality of processor cores and capable of executing a plurality of processes in parallel.

The main memory 42 includes a non-volatile memory area and a volatile memory area. The non-volatile memory area of the main memory 42 stores an operating system and/or application programs. The non-volatile and volatile memory areas of the main memory 42 may store data necessary for the processor 41 to execute a process for controlling each component. The volatile memory area of the main memory 42 is used as a work area in which data is rewritten by the processor 41. The non-volatile memory area is, for example, a ROM (Read Only Memory). The volatile memory area is, for example, a RAM (Random Access Memory).

For example, the auxiliary storage device 43 includes an EEPROM (Electric Erasable Programmable Read-Only Memory), an HDD (Hard Disk Drive), or an SSD (Solid State Drive). The auxiliary storage device 43 stores data used by the processor 41 to perform various types of processing, data created by processing by the processor 41, and the like. The auxiliary storage device 43 may store the above-described application programs.

The clock 44 is a clock circuit that counts the date and time. The processor 41 processes the date and time clocked by the clock 44 as the current date and time.

The first communication interface 45 is a network interface circuit that performs data communication with the shelf label server 22 connected by the inter-server network 33. The shelf label server 22 controls the electronic shelf label 21 provided on an item shelf and capable of displaying the item information related to the item placed on the item shelf. Here, the first communication interface 45 functions as a communication unit that communicates with the controller, that is, the shelf label server 22.

The second communication interface 46 is a network interface circuit that performs data communication with each device connected to the communication network 13. For example, the second communication interface 46 performs data communication with the POS terminals 11. The second communication interface 46 performs data communication with the information terminal 32 via the access point 16. Further, the second communication interface 46 performs data communication with the upper level server via the communication server 15. Here, the second communication interface 46 functions as a second communication unit that communicates with the upper level server.

In order to perform the sharing assist function, the store server 12 having such a configuration uses a part of the storage area of the auxiliary storage device 43 as a shelf information area 51, and a part of the volatile memory area in the main memory 42 as a first buffer 52 and a second buffer 53. The first buffer 52 is an area for temporarily storing a plurality of shelf inspection data until the shelf inspection data is transmitted to an upper level server. The second buffer 53 is an area for temporarily storing a plurality of pieces of item information until the plurality of pieces of item information are transmitted to the electronic shelf label system 20.

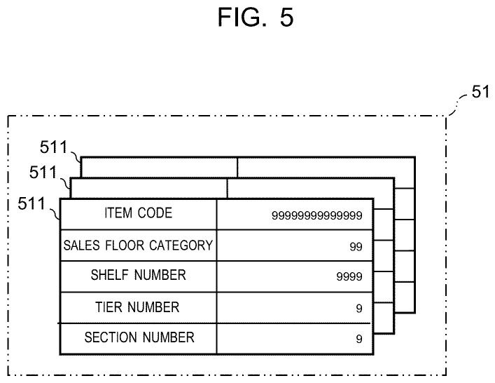

FIG. 5 is a schematic diagram illustrating a data structure of the shelf information area 51. As illustrated, the shelf information area 51 is an area for storing a plurality of shelf information files 511. The shelf information file 511 is a data file storing an item code and shelf information including a sales floor category, a shelf number, a tier number, and a section number. The store server 12 generates a shelf information file 511 based on the shelf inspection data received from the information terminal 32, and stores it in the shelf information area 51.

The processor 41 of the store server 12 performs the functions of an acquisition unit 61, an adding unit 62, a first transmission unit 63, and a second transmission unit 64 in order to realize the sharing assist function.

The acquisition unit 61 acquires item information to be displayed on an electronic shelf label 21. The item information to be displayed on an electronic shelf label 21 is, for example, an item name and a price. Such item information is stored in the item master 14. The acquisition unit 61 acquires item information to be displayed on an electronic shelf label 21 from the item master 14.

The adding unit 62 adds location information indicating a place where the item specified by the item information is placed, to the item information acquired by the acquisition unit 61. The location information indicates the sales floor, the item shelf, the tier, and the section of the item and corresponds to the shelf information input to the information terminal 32. The shelf information is included in a shelf information file 511 stored in the shelf information area 51. The adding unit 62 detects, from the shelf information included in the shelf information file 511, shelf information indicating a place where the item specified by the item information is placed, and adds the shelf information, that is, the location information, to the item information acquired by the acquisition unit 61.

The first transmission unit 63 controls the first communication interface 45 to transmit the item information to which the location information is added to the shelf label server 22. The first transmission unit 63 controls the first communication interface 45 to transmit the item information to which the location information is added to the shelf label server 22 via the inter-server network 33 connected to the first communication interface 45. In some cases, the first transmission unit 63 controls the first communication interface 45 to transmit the item information to which the location information is not added to the shelf label server 22.

The second transmission unit 64 controls the second communication interface 46 to transmit the location information input via the information terminal 32 to the upper level server. The location information input via the information terminal 32 is shelf information included in the shelf inspection data. The second transmission unit 64 controls the second communication interface 46 to transmit the shelf inspection data received via the access point 16 to the upper level server via the communication server 15.

The functions of the acquisition unit 61, the adding unit 62, the first transmission unit 63, and the second transmission unit 64 are all performed by the processor 41 in accordance with one or more operation programs. The operation program is a kind of application program stored in the main memory 42 or the auxiliary storage device 43. A method of installing the operation program in the main memory 42 or the auxiliary storage device 43 is not particularly limited. The operation program can be recorded on a non-transitory computer readable recording medium, or the operation program can be distributed by communication via a network, and installed in the main memory 42 or the auxiliary storage device 43. Any form of recording medium can be used as long as the recording medium can store a program, such as a CD-ROM, a memory, or the like.

The operation program includes a first mode program that assists the inspection operation of item shelves, and a second mode program that assists the maintenance operation of the item master 14. The maintenance operation of the item master 14 is an operation of adding, deleting, and modifying an item record 141 stored in the item master 14. For example, any one of the plurality of POS terminals 11 is a maintenance-dedicated machine. Hereinafter, a maintenance-dedicated POS terminal will be referred to as a dedicated POS terminal 111. An employee in charge of the maintenance operation enters an item record 141 of a newly launched item into the item master 14 into the dedicated POS terminal 111. The employee enters the item record 141 of the item that has been sold out for deletion from the item master 14 into the dedicated POS terminal 111. The employee enters, for example, the item record 141 of an item for which the regular price or the special price has been changed into the dedicated POS terminal 111. As a result of such data entry, maintenance data of the item master 14 is transmitted from the dedicated POS terminal 111 to the store server 12, and maintenance of the item master 14 is performed.

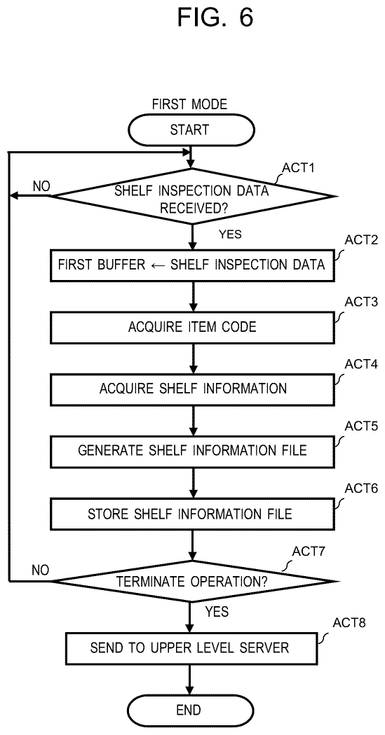

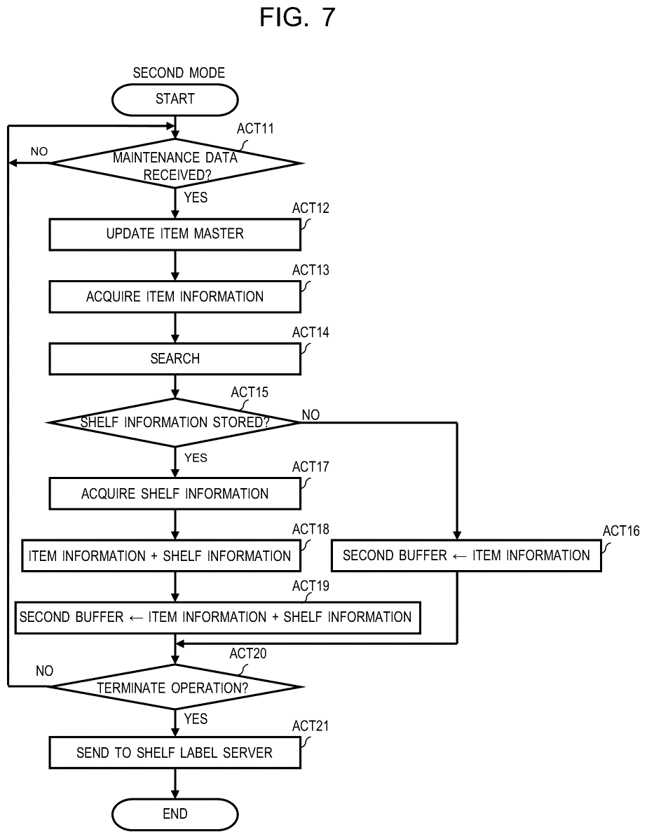

FIG. 6 and FIG. 7 are flowcharts illustrating information processing executed by the processor 41 in accordance with an operation program. Specifically, FIG. 6 shows a procedure when the first mode is selected, and FIG. 7 shows a procedure when the second mode is selected. The information processing described with reference to the flowcharts are examples. The steps and its order can be appropriately changed as long as the same effects can be obtained.

An employee who performs the inspection operation of an item shelf operates the information terminal 32 to instruct to start the operation. Upon receiving this instruction, the processor 41 of the store server 12 selects the first mode. Then, the processor 41 starts the information processing shown in the flowchart of FIG. 6.

The processor 41 waits to receive shelf inspection data in ACT1. When the employee inputs the item code of an item placed on an item shelf, and its shelf information including the sales floor category, the shelf number, the tier number, and the section number into the information terminal 32, the shelf inspection data which is the paired data of the item code and the shelf information is wirelessly transmitted from the information terminal 32. The wirelessly transmitted shelf inspection data is received at the access point 16 and transmitted to the store server 12 through the communication network 13.

The processor 41 receives the shelf inspection data and proceeds to ACT2. The processor 41 writes the shelf inspection data in ACT2 into the first buffers 52. Then, the processor 41 acquires the item code from the shelf inspection data in ACT3. The processor 41 acquires shelf information from the shelf inspection data in ACT4. Then, the processor 41 creates the shelf information file 511 by using the item code and the shelf information in ACT5. The processor 41 stores the shelf information file 511 in ACT6 in the shelf information area 51.

Upon completion of ACT2 to ACT6, the processor 41 proceeds to ACT7. The processor 41 checks whether the termination of the inspection operation has been instructed in ACT7.

The employee repeats a work as an inspection operation of inputting, to the information terminal 32, the item code of each item placed on the item shelf and its shelf information indicating where the item is placed. Then, when the work as the inspection operation is completed, the employee operates the information terminal 32 to instruct to terminate the operation.

In ACT7, the processor 41 returns to ACT1 when the termination of the inspection operation is not instructed. Upon receiving a subsequent shelf inspection data, the processor 41 executes ACT2 to ACT6 processes again. As described above, the processor 41 repeatedly executes ACT2 to ACT6 processes every time the shelf inspection data is received from the information terminal 32. As a result, all the shelf inspection data is stored in the first buffer 52. The shelf information file 511 generated for each shelf inspection data is stored in the shelf information area 51.

In ACT7, the processor 41 proceeds to ACT8 when it is detected that the termination of the inspection operation is instructed. The processor 41 controls the second communication interface 46 to transmit the data stored in the first buffer 52 to the upper level servers in ACT8. By this control, all the shelf inspection data stored in the first buffer 52 is transmitted to the upper level server via the communication server 15. On the basis of the received shelf inspection data, the upper level server generates data that is an important element in considering, for example, a layout change of an item shelf or an arrangement location change of an item.

As described above, the processor 41 ends the information processing at the time of selecting the first mode in the procedure illustrated in the flowchart of FIG. 6. When ACT8 process is completed, the first buffer 52 is cleared. Alternatively, the first buffer 52 may be cleared at a time point when an instruction to start an operation is received from the information terminal 32.

Here, the processor 41 performs the function as the second transmission unit 64 by ACT8 process.

An employee in charge of the maintenance operation of the item master 14 operates a dedicated POS terminal 11 to instruct to start the operation. Upon receiving this instruction, the processor 41 of the store server 12 selects the second mode. Then, the processor 41 starts the information processing shown in the flowchart of FIG. 7.

The processor 41 waits for reception of maintenance data in ACT11. The maintenance data is, for example, data of an item record 141 to be added to the item master 14. The maintenance data may be, for example, data of an item record 141 to be deleted from the item master 14. The maintenance data may be, for example, data of an item record 141 in which the regular price or the special price is changed.

Upon receiving the maintenance data from POS terminal 11, the processor 41 proceeds to ACT12. The processor 41 updates the item master 14 based on the maintenance data in ACT12. For example, when the maintenance data is data of an item record 141 to be added to the item master 14, the processor 41 adds the item record 141 to the item master 14. For example, when the maintenance data is data of an item record 141 to be deleted from the item master 14, the processor 41 deletes the item record 141 from the item master 14. For example, when the maintenance data is data of an item record 141 in which the regular price or the special price is changed, the processor 41 changes the regular price or the special price of the item record 141 stored in the item master 14.

The processor 41 that has updated the item master 14 proceeds to ACT13. The processor 41 acquires item information such as an item code, an item name, and a price, from the item record 141 of the item master 14 updated by the maintenance data. Then, the processor 41 searches the shelf information area 51 with the item code of the item information acquired in ACT14. In ACT15, the processor 41 checks whether a shelf information file 511 including the item code is stored in the shelf information area 51.

When no shelf information file 511 including the item code of the acquired item information is stored in the shelf information area 51, the processor 41 proceeds to ACT16. The processor 41 writes the item information in ACT16 into the second buffer 53.

When a shelf information file 511 including the item code of the acquired item information is stored in the shelf information area 51, the processor 41 proceeds to ACT17. The processor 41 acquires shelf information from the shelf information file 511 in ACT17. The processor 41 adds the shelf information to the item information in ACT18. The processor 41 writes the item information to which the shelf information is added in ACT19 into the second buffers 53.

Upon completion of ACT16 or ACT19, the processor 41 proceeds to ACT20. The processor 41 checks whether an instruction to terminate the maintenance operation is issued in ACT20.

The employee repeats the operation of inputting data required for maintenance of the item master 14 to the dedicated POS terminal 111. When the maintenance operation is terminated, the employee operates the dedicated POS terminal 111 to instruct to terminate the operation.

In ACT20, the processor 41 returns to ACT11 when the termination of the maintenance operation is not instructed. Upon receiving the subsequent maintenance information, the processor 41 executes ACT12 to ACT19 process again. As described above, the processor 41 repeatedly executes ACT12 to ACT19 processes every time maintenance data is received from the dedicated POS terminal 111. As a result, the item information included in the maintenance data is stored in the second buffer 53. When the shelf information associated with the item code included in the item information is stored in the shelf information area 51, the shelf information is added to the item information and stored in the second buffer 53.

In ACT20, the processor 41 proceeds to ACT21 when it is detected that the termination of the maintenance operation is instructed. The processor 41 controls the first communication interface 45 to transmit the data stored in the second buffer 53 to the shelf label server 22 in ACT21. By this control, all the item information stored in the second buffer 53 is transmitted to the shelf label server 22 via the inter-server network 33. Therefore, when shelf information associated with an item code included in item information is stored in the shelf information area 51, the item information to which the shelf information is added is transmitted to the shelf label server 22. When shelf information associated with an item code included in item information is not stored in the shelf information area 51, the item information to which any shelf information is not added is transmitted to the shelf label server 22.

As described above, the processor 41 ends the information processing illustrated in the flowchart of FIG. 7. When ACT21 process is completed, the second buffer 53 is cleared. Alternatively, the second buffer 53 may be cleared at the time when the instruction to start the operation is received from the dedicated POS terminal 111.

Here, the processor 41 performs the function as the acquisition unit 61 by ACT13 process. The processor 41 performs the function as the adding unit 62 by ACT18 process. The processor 41 performs the function as the first transmission unit 63 by ACT21 process.

As described above in detail, the store server 12 acquires, by the acquisition unit 61, the item information to be displayed on the electronic shelf label 21, adds, by the adding unit 62, the location information indicating the place where the item specified by the item information is placed to the item information, and performs the function of transmitting, by the first transmission unit 63, the item information to which the location information is added to the shelf label server 22. With this function, the shelf information of the shelf inspection data received from the information terminal 32 in the inspection operation of the merchandise shelf, that is, the location information of the merchandise can be shared by the electronic shelf label system having the position information of the electronic shelf label 21 corresponding to the location information. As a result, in the electronic shelf label system 20, it is possible to check whether the information of the item displayed on the electronic shelf label 21 having the position information corresponding to the shared location information (i.e., shelf information), for example, is the information of the item identified by the item code paired with the location information. That is, the display of an electronic shelf label can be automatically checked in accordance with the inspection operation of the item shelf.

Although some particular embodiments have been described above, embodiments of this disclosure are not limited thereto. In the above-described embodiments, the store server 12 is described as an information processing apparatus, but the information processing apparatus is not limited to the store server 12. For example, the communication server 15 may be an information processing apparatus. Further, a dedicated server may be incorporated in the POS system 10, and the server may be an information processing apparatus.

In the above embodiments, a case has been exemplified in which the store server 12 receives the location information input via the information terminal 32 via the communication unit and stores the location information in the shelf information area 51. In this regard, the location information input via the information terminal 32 may be recorded in a removable recording medium, read by a medium reading unit included in the store server 12, and stored in the shelf information area 51.

The inspection operation of an item shelf is not limited to an input operation, to the information terminal, information indicating where the item is placed on the item shelf. For example, it may be an inventory operation of inputting the inventory quantity remaining in the item shelf.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A store management system, comprising:
a plurality of electronic shelf labels each configured to display item information indicating one of a plurality of items sold in a store;
a shelf label server configured to communicate with the electronic shelf labels and store the item information displayed by each of the electronic shelf labels in association with a corresponding shelf label location information indicating a location of said each of the electronic shelf labels in the store; and
a store server configured to:
store, in a memory, item location information for each of the items that indicates a location of said each of the items in the store in association with an item code of said each of the items,
retrieve, from a database, item information for each of the items using the item code of said each of the items, and
for each of the items, transmit the item information retrieved from the database using the item code thereof along with the item location information thereof to the shelf label server, wherein
the shelf label server is configured to transmit each item information received from the store server to a selected electronic shelf label for display by the selected electronic shelf label, wherein the selected electronic shelf label is one of the electronic shelf labels that is located at or nearest to the location indicated by the item location information received with the item information.

2. The store management system according to claim 1, wherein the store server is configured to transmit the item code and the item location information for each of the items to an external server that is different from the shelf label server.

3. The store management system according to claim 1, further comprising:
a mobile terminal connectable to the store server, wherein
the store server acquires the item location information for each of the items from the mobile terminal.

4. The store management system according to claim 3, wherein the mobile terminal is configured to receive an input of a sales floor, a number of a shelf, and a tier number and a section number of the shelf as the item location information.

5. The store management system according to claim 3, further comprising:
a point of sale (POS) terminal installed in the store, and configured to receive an input of the item information for each of the items and store the input item information in the database.

6. The store management system according to claim 5, wherein the item information for each of the items indicates an item code, a name, a price, and promotional information of said each of the items.

7. The store management system according to claim 5, further comprising:
a first network in which the store server and the POS terminal are connected to each other; and
a second network in which the shelf label server and the electronic shelf labels are connected to each other, wherein
the first and second networks are connected by a third network.

8. A method performed by a store management system that includes:
a plurality of electronic shelf labels each configured to display item information indicating one of a plurality of items sold in a store,
a shelf label server configured to communicate with the electronic shelf labels and store the item information displayed by each of the electronic shelf labels in association with a corresponding shelf label location information indicating a location of said each of the electronic shelf labels in the store, and
a store server, the method comprising:
storing, in a memory of the store server, item location information for each of the items that indicates a location of said each of the items in the store in association with an item code of said each of the items;
retrieving, from a database stored in the store server, item information for each of the items using the item code of said each of the items;
for each of the items, transmitting the item information retrieved from the database using the item code thereof along with the item location information thereof from the store server to the shelf label server; and
transmitting each item information received from the store server from the shelf label server to a selected electronic shelf label for display by the selected electronic shelf label, wherein the selected electronic shelf label is one of the electronic shelf labels that is located at or nearest to the location indicated by the item location information received with the item information.

9. The method according to claim 8, further comprising:
transmitting the item code and the item location information for each of the items from the store server to an external server that is different from the shelf label server.

10. The method according to claim 8, further comprising:
acquiring the item location information for each of the items from a mobile terminal.

11. The method according to claim 10, further comprising:
receiving, by the mobile terminal, an input of a sales floor, a number of a shelf, and a tier number and a section number of the shelf as the item location information.

12. The method according to claim 10, further comprising:
by a point of sale (POS) terminal, receiving an input of the item information for each of the items, and storing the input item information in the database.

13. The method according to claim 12, wherein the item information for each of the items indicates the item code, a name, a price, and promotional information of said each of the items.

14. The method according to claim 12, further comprising:
connecting the store server and the POS terminal via a first network;
connecting the shelf label server to the electronic shelf labels via a second network; and
connecting the first and second networks via a third network.

15. A store server in a store management system that includes a plurality of electronic shelf labels each configured to display item information indicating one of a plurality of items sold in a store, the store server comprising:
a communication interface connectable to a shelf label server of the store management system, the shelf label server being configured to communicate with the electronic shelf labels and store the item information displayed by each of the electronic shelf labels in association with a corresponding shelf label location information indicating a location of said each of the electronic shelf labels in the store;
a memory; and
a processor configured to:
store, in the memory, item location information for each of the items that indicates a location of said each of the items in the store in association with an item code of said each of the items,
retrieve, from a database, item information for each of the items using the item code of said each of the items, and
control the communication interface to transmit, for each of the items, the item information retrieved from the database using the item code thereof along with the item location information thereof to the shelf label server such that each item information is displayed by a selected electronic shelf label, which is one of the electronic shelf labels that is located at or nearest to the location indicated by the item location information received with the item information.

16. The store server according to claim 15, wherein the processor is configured to control the communication interface to transmit the item code and the item location information for each of the items to an external server that is different from the shelf label server.

17. The store server according to claim 15, wherein the processor is configured to acquire the item location information for each of the items from a mobile terminal.

18. The store server according to claim 17, wherein the item location information indicates a sales floor, a number of a shelf, and a tier number and a section number of the shelf.

19. The store server according to claim 17, wherein the item information for each of the items is stored in the database by a point of sale (POS) terminal.

20. The store server according to claim 19, wherein the item information for each of the items indicates an item code, a name, a price, and promotional information of said each of the items.
